(19) United States
(12) Patent Application Publication
(10) Pub. No.: US 2024/0078989 A1
(43) Pub. Date: Mar. 7, 2024

(54) INFORMATION PROCESSING METHOD, INFORMATION PROCESSING APPARATUS, STORAGE MEDIUM FOR STORING PROGRAM, AND INFORMATION PROCESSING SYSTEM

(71) Applicant: CASIO COMPUTER CO., LTD., Tokyo (JP)

(72) Inventor: Shigeru KAFUKU, Tokyo (JP)

(73) Assignee: CASIO COMPUTER CO., LTD., Tokyo (JP)

(21) Appl. No.: 18/128,653

(22) Filed: Mar. 30, 2023

(30) Foreign Application Priority Data
Sep. 7, 2022 (JP) 2022-142235

(51) Int. Cl. G10H 1/36; B41J 3/407; G06F 16/958; G06K 1/12; G06T 1/00

(52) U.S. Cl. CPC G10H 1/36; B41J 3/4075; G06F 16/972; G06K 1/121; G06T 1/0035; G10H 2210/091

(57) ABSTRACT

An information processing method performed by at least one processor, the method comprising:
acquiring performance information corresponding to performance operation; generating an image based on the performance information;
storing at least one of the image and the performance information in a storage device;
acquiring address information for accessing the at least one of the image and the performance information stored in the storage device; and
controlling an output device to output the address information.

### BACKGROUND OF THE INVENTION

### Technical Field

The present disclosure relates to an information processing method, an information processing apparatus, a storage medium for storing a program, and an information processing system.

### Background Art

When a user plays an electronic musical instrument, performance information is input to an information processing apparatus, and the information processing apparatus analyzes the performance information. Thus, the information processing apparatus generates an image corresponding to the performance and displays the image.

### RELATED ART DOCUMENTS

### Patent Document 1

Japanese Patent Publication No. 2019-101168

### SUMMARY OF THE INVENTION

When an event utilizing the technology described in the Patent Document 1 is held, for example, the information processing apparatus generates an image in response to a free performance of an electronic musical instrument by a visitor. In such an event, as a method for providing the image to the visitor (performer), for example, there is a method of printing the image by a printing apparatus and providing it to the visitor.

However, in this method, when the printing apparatus runs out of paper or ink, it is necessary to take measures against the issues by a human. After the event, visitors were not able to listen to the performances they performed at the event at home or share performance information.

In other words, the technology in the Patent Document 1 couldn't provide the images and performance information which generated based on the visitor's performance to the visitors satisfactory.

Therefore, an information processing method performed by at least one processor, the method comprising: acquiring performance information corresponding to performance operations; generating an image based on the performance information; storing at least one of the image and the performance information in a storage device; acquiring address information for accessing the at least one of the image and the performance information stored in the storage device; and controlling an output device to output the address information.

### BRIEF DESCRIPTION OF DRAWINGS

FIG. 1 is a diagram showing an overall configuration example of an information processing system according to the embodiment.

FIG. 2 is a block diagram showing a functional configuration of the information processing apparatus.

FIG. 3 is a diagram showing a sequence from a start of a performance by a performer to an output of URL information for accessing a generated image and performance information in the information processing system.

FIG. 4 is a diagram showing parameters used for generating an image (first image).

FIG. 5 is a diagram showing an example of an image (second image) displayed by a display apparatus and a label output by a label printer based on an instruction from the information processing apparatus.

FIG. 6 is a diagram showing a sequence executed between a user terminal and the server when the user terminal reads a two-dimensional code of the label.

### DETAILED DESCRIPTION OF EMBODIMENTS

An embodiment for carrying out the present disclosure will be described below with reference to the drawings. The embodiments described below may include various limiting descriptions in order to illustrate the present disclosure. However, the technical scope of the present disclosure is not limited to the following embodiments and illustrated examples.

[Configuration of Information Processing System 100]

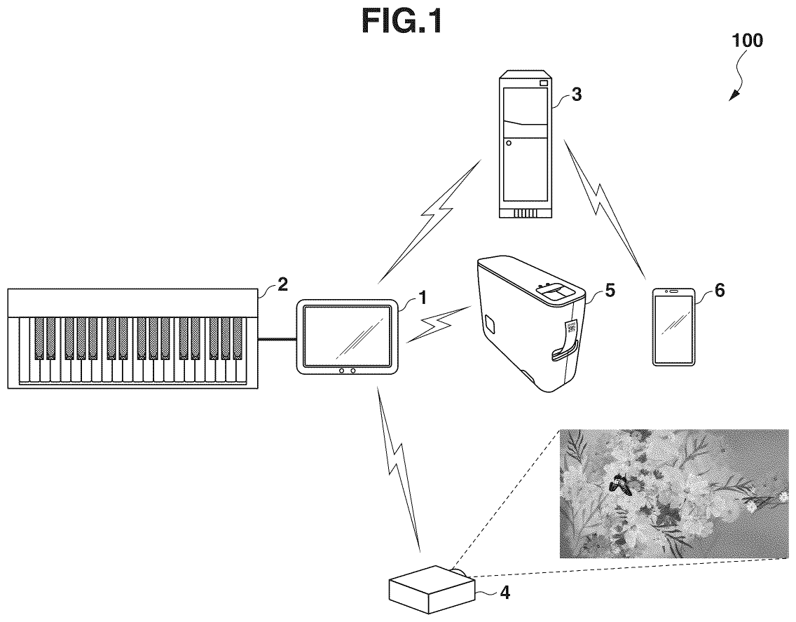

FIG. 1 is a diagram showing an overall configuration example of the information processing system 100 of the present disclosure.

As shown in FIG. 1, the information processing system 100 includes the information processing apparatus 1, an electronic musical instrument 2, a server 3, a display device 4, the label printer 5, and the user terminal 6. The information processing apparatus 1 is connected to the electronic musical instrument 2, the server 3, the display device 4, and the label printer 5 in such a way that data can be transmitted and received by wire or wirelessly. The user terminal 6 is connectable to the server 3 via at least one of the wireless LAN (Local Area Network) such as WiFi, the cellular phone communication network, the Internet, or the like.

At least the information processing apparatus 1, the electronic musical instrument 2, the display device 4, and the label printer 5 of the information processing system 100 are placed in the event hall, and visitors can freely play the electronic musical instrument 2.

Hereinafter, each device included in the information processing system 100 will be described.

[Information Processing Apparatus 1]

The information processing apparatus 1 is an apparatus for generating an image corresponding to a performance based on performance information inputted in response to a performance operation performed by the electronic musical instrument 2. The performance information is, for example, MIDI (Musical Instrument Digital Interface) data.

Specifically, the information processing apparatus 1 analyzes the performance information inputted by the electronic musical instrument 2 in real time, generates an image corresponding to the performance (hereinafter a first image) in real time, and displays it on the display device 4. In response to the performance ends, the information processing apparatus 1 generates an image corresponding to the entire performance (hereinafter as a second image) and displays it on the display device 4. The second image is a performance summary image that summarizes the entire performance. Further, the information processing apparatus 1 transmits the second image and the performance information to the server 3, and upon receiving URL (Uniform Resource Locator) information as address information for accessing the second image and the performance information from the server 3, generates the two-dimensional code representing the received URL information, and causes the label printer 5 to output the two-dimensional code.

The information processing apparatus 1 may be a tablet PC (Personal Computer), a notebook PC or a smartphone.

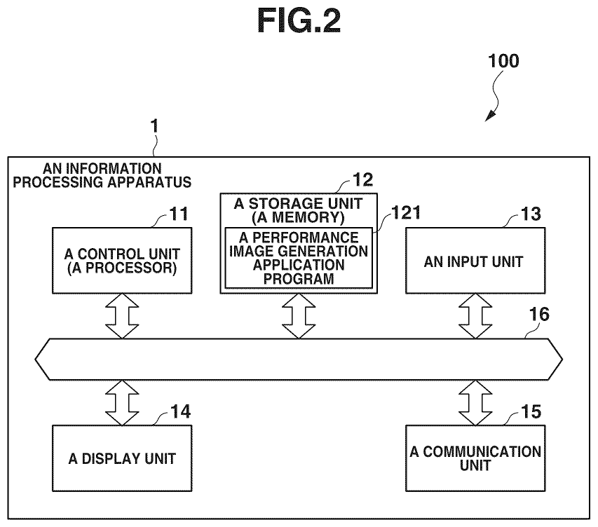

FIG. 2 is a block diagram showing a functional configuration of the information processing apparatus 1. As shown in FIG. 2, the information processing apparatus 1 includes a control unit 11 (hereinafter a processor 11), a storage unit 12 (hereinafter a memory 12), an input unit 13 (a keyboard), a display unit 14 (a display device), a communication unit 15 (a communication apparatus) and the like. Each unit is connected by a bus 16.

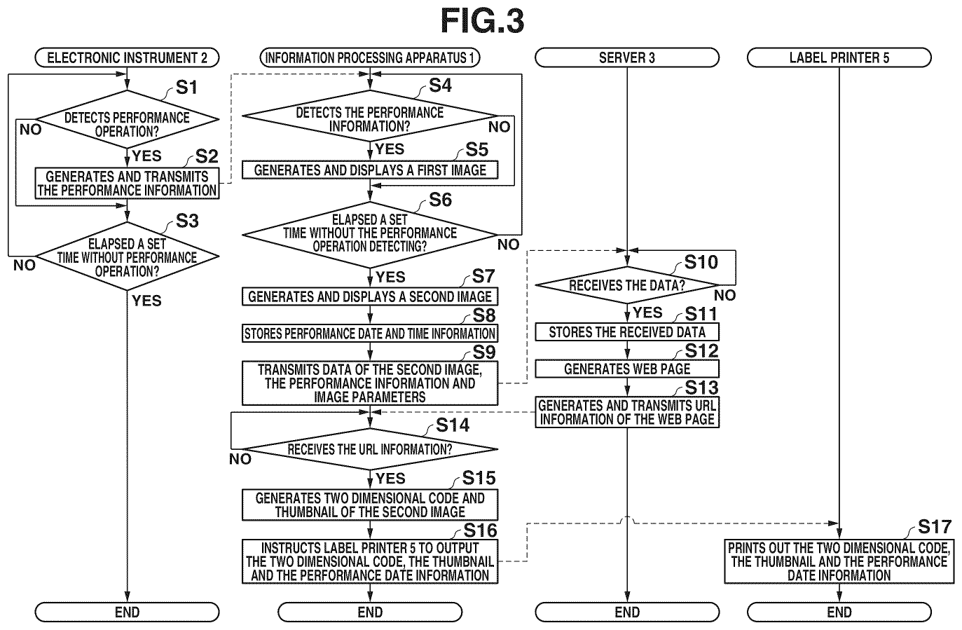

The control unit 11 includes at least one CPU (Central Processing Unit), RAM (Random Access Memory), and the like. The control unit 11 is a computer for controlling each unit of the information processing apparatus 1. More specifically, the CPU of the control unit 11 reads out a specified program from among system programs and various application programs stored in the storage unit 12 and loads it into the RAM. The CPU of the control unit 11 executes various processes including processes on the information processing apparatus 1 side shown in FIG. 3 in cooperation with the loaded program.

The storage unit 12 includes a nonvolatile semiconductor memory and an HDD (Hard Disk Drive). The storage unit 12 stores the system programs of the information processing apparatus 1, the various application programs, and data necessary for executing the programs. The storage unit 12 is not limited to one built in the information processing apparatus 1. The storage unit 12 may include an external recording medium that is detachable from the information processing apparatus 1. In the present embodiment, the storage unit 12 stores a performance image generation application program 121 for executing the processing on the information processing apparatus 1 side shown in FIG. 3.

The input unit 13 includes a push button switch and a touch panel attached to the display unit 14. The input unit 13 outputs an operation signal of the push-button switch and an operation signal on the screen by the user to the control unit 11.

The display unit 14 includes an LCD (Liquid Crystal Display) and an EL (Electro Luminescence) display. The display unit 14 is an output device that performs various displays according to display information instructed from the control unit 11. The information processing apparatus 1 may also serve as an output apparatus (label printer 5) for outputting the URL information or as the display apparatus 4.

The communication unit 15 includes a wireless unit having an antenna or/and a wired unit having an external connection terminal for performing communication with an external device and performing data transmission/reception with the external device.

[Electronic Musical Instrument 2]

The electronic musical instrument 2 is, for example, a keyboard musical instrument. The electronic musical instrument 2 is provided with a keyboard having a plurality of keys for a player to perform performance operations. The electronic musical instrument 2 generates a tone waveform in accordance with the playing operation on the keyboard and outputs a sound. Further, the electronic musical instrument 2 generates performance information corresponding to the performance operation and transmits the performance information to the information processing apparatus 1 via a communication unit (not shown). The performance information includes a note on message of a key depressed, a note number (a key number of the depressed key), a velocity value, or a note off message of a key released, a note number (a key number of the released key), a velocity value, etc. Note numbers are also referred to as pitch information.

[Server 3]

The server 3 includes a control unit, a storage unit, and a communication unit. The server 3 is a storage device that stores the second image, the performance information, and an image parameter transmitted from the information processing apparatus 1 in a storage unit in association with each other. The server 3 also generates address information for accessing the second image and the performance information stored in the storage unit and transmits the generated address information to the information processing apparatus 1. In this embodiment, the server 3 generates a Web page for viewing the second image and listening to a performance based on the performance information and transmits URL information for accessing the Web page to the information processing apparatus 1.

[Display Device 4]

The display device 4 is an output device that performs display in response to an instruction from the information processing apparatus 1. The display device 4 may be a projector for projecting an image onto a projection surface such as a screen or may be a monitor (large monitor) such as a liquid crystal display or an organic EL display.

[Label Printer 5]

The label printer 5 has a long recording medium wound in a roll shape. The label printer 5 is an output device for printing on the recording medium in response to an instruction from the information processing apparatus 1.

[User Terminal 6]

The user terminal 6 is a terminal device owned by the player or the like, such as a smartphone or a tablet terminal. The user terminal 6 includes a control unit, a storage unit, an input unit, a display unit, a camera, a communication unit, and the like. Since the two-dimensional code reader application program and a Web browser are installed in the user terminal 6, it is possible to read the two-dimensional code and access the Web page.

[Operation of Information Processing System 100]

Next, an operation of the information processing system 100 will be described.

In the information processing system 100, when a performance is performed in the electronic musical instrument 2, images (first image, second image) corresponding to the performance are generated in the information processing apparatus 1, and the generated images are displayed on the display device 4. The generated second image and performance information are transmitted to the server 3. The server 3 stores the second image and performance information. The server 3 generates the Web page and its URL information for viewing the second image and listening to the performance based on the performance information. The generated URL information is transmitted to the information processing apparatus 1. When the information processing apparatus 1 receives the URL information transmitted from the server 3, the two-dimensional code representing the URL information and a thumbnail of the second image are generated and printed out by the label printer 5. As a result, the URL information for accessing the Web page for viewing the second image and listening to the performance based on the performance information is transmitted to the performer. When the camera of the user terminal 6 is held over the two-dimensional code output by the label printer 5, the two-dimensional code is read by the user terminal 6, URL information is acquired, and the Web page can be accessed by the acquired URL information. That is, the user can view the second image and listen to the performance based on the performance information.

FIG. 3 is a diagram showing a sequence in the information processing system 100 from the start of the performance by the performer in the electronic musical instrument 2 to the output of the URL information by the label printer 5. The sequence shown in FIG. 3 will be described below.

The electronic musical instrument 2 determines that there is a performance operation (key depression or key release) whether or not (step S1), if it is determined that there is the performance operation (step S1; YES), in other words, if the electronic musical instrument 2 detects performance operation, the electronic musical instrument 2 generates performance information (e.g., MIDI data) based on the performance operation and transmits the performance information to the information processing apparatus 1 (step S2). Thereafter, the process proceeds to step S3.

If it is determined that there is no performance operation (step S1; NO), the electronic musical instrument 2 executes the process of step S3.

In step S3, the electronic musical instrument 2 determines whether or not a predetermined time (a set time) has elapsed in a state where there is no performance operation (step S3).

If it is determined that the predetermined time has not elapsed in the state where no performance operation is performed (step S3; NO), the process returns to step S1.

If it is determined that the predetermined time has elapsed in the state where there is no performance operation (step S3; YES), the electronic musical instrument 2 determines that the performance has ended and ends these processes.

In the information processing apparatus 1, the control unit 11 determines whether or not the performance information has been input from the electronic musical instrument 2 via the communication unit 15 (step S4).

If it is determined that the performance information has been input from the electronic musical instrument 2 via the communication unit 15 (step S4; YES), in other words, if the information processing apparatus 1 detects the performance information, the control unit 11 acquires the input performance information and analyzes the performance information in real time. The control unit 11 generates the first image corresponding to the performance based on the analysis result. Then, the communication unit 15 transmits the generated first image to the display device 4, instructs the display device 4 to display the first image, and causes the display device 4 to display the first image (step S5), and the process proceeds to step S6. The control unit 11 may display the first image on the display unit 14.

In this embodiment, an expression “instruct” can be read as “control”.

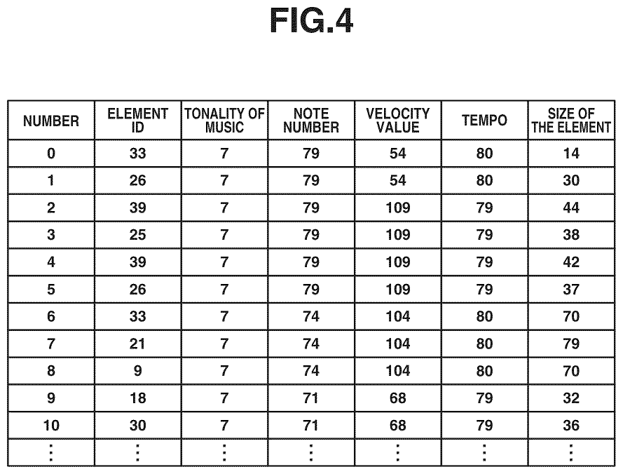

In step S5, the control unit 11 analyzes the input performance information and determines the tonality of the music, pitch (note) velocity and tempo. The control unit 11 determines the type of element to be drawn (for example, an image of a flower or a leaf), the size of the element, and the like based on the determined information, and generates the first image corresponding to the performance. As a method for generating the first image and the second image from the performance information, for example, the method described in Japanese published Patent Application No. 2019/101168 can be used, but the method is not limited thereto. The control unit 11 transmits the generated first image to the display device 4 so that the display device 4 displays the first image. The control unit 11, as shown in FIG. 4, records an image parameter used to generate the first image in the RAM. The image parameter used to generate the first image includes pitch (note) and velocity value included in the performance information, tonality or tempo, which is the result of analysis of the performance, an element ID indicating the type of the drawn element, the size of the element, and the like. The element corresponding to the element ID is stored in the storage unit 12.

When it is determined that the performance information is not input from the electronic musical instrument 2 through the communication unit 15 (step S4; NO), the control unit 11 proceeds to step S6.

In step S6, the control unit 11 determines whether or not the predetermined period of time has elapsed with no performance information is input (step S6).

If it is determined that the predetermined time has not elapsed with no input of performance information (step S6; NO), the process returns to step S4, and the control unit 11 repeatedly executes steps S4 to S6.

If it is determined that the predetermined time has elapsed without input of the performance information (step S6; YES), the control unit 11 determines that the performance has ended and generates the second image that summarizes the entire performance. Then, the control unit 11 transmits the generated second image from the communication unit 15 to the display device 4. Then, the control unit 11 instructs the display device 4 to display the second image and causes the display device 4 to display the second image (step S7).

In step S7, the control unit 11 generates the second image based on the image parameters (image parameter group) used for generating the plurality of first images generated during the performance. The image parameters (image parameter group) are stored in the RAM. The control unit 11 transmits the generated second image from the communication unit 15 to the display device 4 and displays the second image on the display device 4 (see FIG. 1). The control unit 11 may display the second image on the display unit 14.

Next, the control unit 11 acquires current date and time as the performance date and time when the performance was performed and stores the performance date and time information in the RAM (step S8).

Next, the control unit 11 transmits data of the second image, the performance information, and the image parameters from the communication unit 15 to the server 3 (step S9).

When the server 3 receives the data of the second image, the performance information, and the image parameter from the information processing apparatus 1 (step S10; YES), the server 3 stores the received data in the storage unit of the server 3 in association with each other (step S11).

Next, the server 3 generates the Web page for viewing the second image and for listening to the performance based on the performance information, and stores data related to the Web page in the storage unit (step S12).

Then, the server 3 generates URL information for accessing the generated Web page and transmits the URL information to the information processing apparatus 1 (step S13).

When the information processing apparatus 1 receives the URL information from the server 3 via the communication unit 15 (step S14; YES), the control unit 11 acquires the received URL information and generates the two-dimensional code representing the URL information and the thumbnail of the second image (step S15).

For example, the control unit 11 encodes the received URL information to generate the two-dimensional code (e.g., a QR code (R)) representing the URL information. Further, for example, the control unit 11 applies dither processing to the second image to binarize it and reduces the image size, thereby generating a black and white binary thumbnail.

Then, the control unit 11 transmits the generated data of the two-dimensional code, the thumbnail of the second image, and the performance date information to the label printer 5 from the communication unit 15. The control unit 11 instructs the label printer 5 to output the two-dimensional code, the thumbnail of the second image, and the performance date information (step S16).

The label printer 5 prints out the two-dimensional code, the thumbnail of the second image, and the performance date information in accordance with the instruction of the information processing apparatus 1 (step S17).

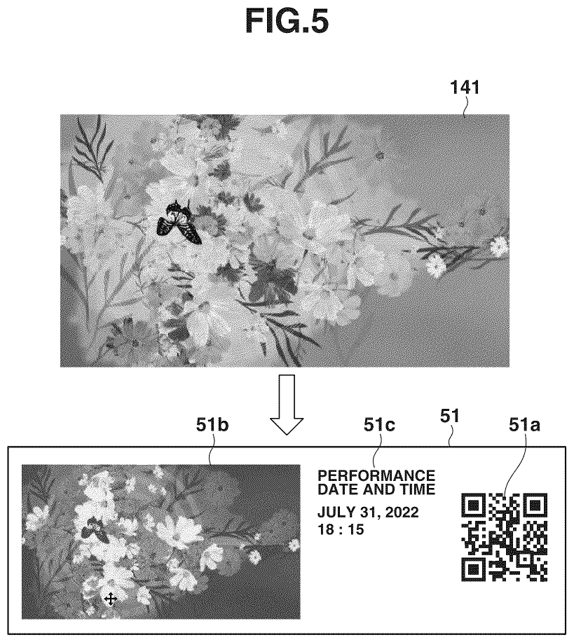

FIG. 5 is a diagram showing an example of the second image 141 output by the display device 4 and a label 51 output by the label printer 5.

As shown in FIG. 5, the label 51 includes the two-dimensional code 51a indicating URL information, the thumbnail 51b of the second image, and the performance date and time 51c.

The label printer 5 uses the long recording medium wound in the roll shape (for example, a tape member), and the size of the two-dimensional code is very small compared with original size of the second image. Therefore, even when the two-dimensional code is printed by the label printer 5, the frequency of running out of a paper or running out of ink is very low. Therefore, by using the label printer 5 to automatically print out the two-dimensional code representing the URL information for accessing the second image and the performance information, it is possible to automatically provide the URL information for accessing the second image and the performance information to the performer without requiring any manual operation. In other words, it is possible to provide the player with the image or the performance information generated in accordance with the performance in a manner that can be shared with others.

Further, by printing not only the two-dimensional code 51a but also the thumbnail 51b of the second image and the performance date and time 51c, the performer can distinguish ones two-dimensional code from the two-dimensional code of another performer. As a result, it is possible to reduce the possibility that the label on which the two-dimensional code for another player is printed is mistakenly carried away.

The performer acquires the label 51 output from the label printer 5, activates the two-dimensional code reader application on the user terminal 6 held by the performer, and holds the user terminal 6 over the two-dimensional code 51a of the label 51.

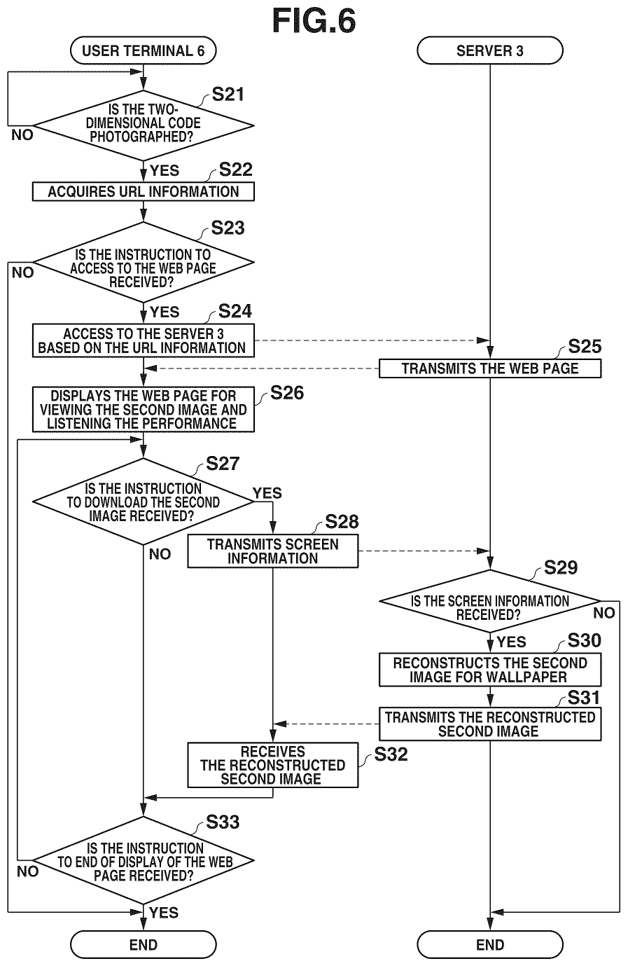

FIG. 6 is a diagram showing a flow of a sequence executed between the user terminal 6 and the server 3 when the two-dimensional code reader application is activated in the user terminal 6 and the user terminal 6 is held over the two-dimensional code 51a of the label 51. The sequence shown in FIG. 6 will be described below.

When the user terminal 6 waits for the photographing of the two-dimensional code 51a by the camera and the two-dimensional code 51a is photographed (step S21; YES), the user terminal 6 decodes the photographed two-dimensional code 51a and acquires URL information (step 22).

Next, the user terminal 6 determines whether or not access to the Web page based on the acquired URL information is instructed by the user operation (step S23).

When it is determined that access to the Web page based on the acquired URL information is instructed (step S23; YES), the user terminal 6 accesses the server 3 based on the acquired URL information and requests transmission of the Web page specified by the URL information (step S24).

When the user terminal 6 requests access to the Web page based on the URL information, the server 3 reads the Web page specified by the URL information and transmits it to the user terminal 6 (step S25).

The user terminal 6 displays the Web page transmitted from the server 3, i.e., the Web page for viewing the second image and listening the performance based on the performance information, by the Web browser (step S26).

In step 26, the Web page displays the second image and user interfaces (play button, stop button, pause button, etc.) for viewing the performance based on the performance information. The performer can enjoy viewing the second image and listening to the performance by playing the performance information on the Web page. Further, a DL button is displayed on the Web page for instructing a download of the second image obtained by reconstructing the second image according to the display screen of the user terminal 6.

When the user terminal 6 is instructed to download the second image by pressing the DL button from the Web page (step S27; YES), the user terminal 6 requests the server 3 to download the second image and transmits screen information (for example, the number of horizontal pixels and the number of vertical pixels) of the user terminal 6 to the server 3 (step S28).

When the server 3 receives the request for downloading the second image and the screen information from the user terminal 6 (step S29; YES), the server 3 reconstructs the second image for wallpaper in accordance with the size of the display screen of the user terminal 6 (step S30), and transmits the reconstructed second image (reconstructed image) to the user terminal 6 (step S31).

The server 3 reads the image parameters received together with the second image displayed on the Web page from the storage unit, and reconstructs the second image suitable for the size and resolution of the display screen of the user terminal 6 based on the read image parameters. In the case where the specification of the control unit of the server 3 is high and performance information can be read and analyzed at high speed, the second image according to the display screen of the user terminal 6 may be reconstructed from performance information without using the image parameters. In this case, it is not necessary to transmit the image parameter from the information processing apparatus 1 to the server 3 in step S9 of FIG. 3.

The user terminal 6 receives the second image transmitted from the server 3 (step S32).

The players can enjoy the second image by downloading it and displaying it as wallpaper.

When the end of display of the Web page is instructed (step S33; YES), the user terminal 6 closes the Web page and ends the sequence executed with the server 3.

As described above, since the information processing system 100 generates the URL information for accessing the second image and the performance information corresponding to the performance of the performer and outputs the two-dimensional code representing the URL information, it is possible to provide the URL information to the performer without the need for manual operation (without user intervention). Therefore, the second image and the performance information generated in accordance with the performance can be easily provided to the performer.

Also, by sharing the two-dimensional code (URL information) acquired by the performer with others, it is possible to enjoy the second image and the performance information with others.

In the embodiment described above, it is assumed that the label printer 5 prints out the two-dimensional code representing the URL information for accessing the second image corresponding to the performance and the performance information. However, the method of outputting the two-dimensional code is not limited to this example. For example, the control unit 11 can superimpose the two-dimensional code representing the URL information on the second image, and can instruct the display device 4 or the display unit 14 of the information processing apparatus 1 to display the second image superimposed with the two-dimensional code, so that the second image is displayed on the display device 4 or the display unit 14. In this case, the control unit 11 may control the display device to display the second image without displaying the two-dimensional code for a certain period of time, or display the two-dimensional code in an inconspicuous position of the second image so as not to impair an artistic quality of the second image.

In the above-described embodiment, when the control unit 11 of the information processing apparatus 1 receives the URL information from the server 3, the control unit 11 generates the two-dimensional code of the URL information and causes the label printer 5 to print it out in step S15-16 shown in FIG. 3. However, the method of outputting the URL information is not limited to this example.

For example, in steps S15-S16 in FIG. 3, the control unit 11 generates a digital watermark image in which the URL information is embedded in the second image, the digital watermark image can be transmitted to the display apparatus 4 so as to instruct the display apparatus 4 to display the digital watermark image.

Alternatively, the display of the digital watermark image can be instructed to the display unit 14 to display the digital watermark image. In this case, in step S7 in FIG. 3, the second image is not displayed on the display apparatus 4 and the display unit 14 of the information processing apparatus 1. Therefore, the information processing apparatus 1 prevents the performer from taking the second image without including the digital watermark.

When the digital watermark image displayed by the display device 4 is photographed by the user terminal 6, the user terminal 6 acquires the URL information from the digital watermark image. Since the processing after acquiring the URL information is the same as the processing in step S23 and subsequent steps in FIG. 6, the description thereof is incorporated.

In the above embodiment, although the Web page is generated for each performance, a common Web page can be prepared in advance. The URL information of the common Web page is displayed, for example, in the form of a two-dimensional code, at a place where the performer can see. For example, a card on which the two-dimensional code is printed can be placed on the electronic musical instrument 2 so that the performer can take it home. A poster on which the two-dimensional code is printed can be put up near the electronic musical instrument 2. The server 3 receives the second image, performance information and image parameters from the information processing apparatus 1, the received second image and the received performance information are added to the common Web page. The performer can view the common Web page by taking a picture of the two-dimensional code representing URL information of the common Web page with the camera in the user terminal 6. The second image and the performance information added to the Web page are deleted after a certain period of time in the server 3.

According to above embodiments, data corresponding to the performance within a predetermined period of time is uploaded to the common Web page in addition to the performance of the performer himself or herself. Therefore, the performer can view the second image or the performance of another person by searching based on the time or place of the performance. It is also possible to share and enjoy the data of the second image and the performance information with others. Further, since individual URL information is not generated for each performance, it is possible to omit the step of generating a different two-dimensional code for each performance and presenting it to the performer. It also avoids confusion when someone doesn't come to pick up the printed two-dimensional code. In addition, when the performer plays a plurality of pieces of music, the performer can access a plurality of second images and a plurality of pieces of performance information with one access.

As described above, the control unit 11 of the information processing apparatus 1 acquires performance information corresponding to the performance operation from the electronic musical instrument 2, generates the second image corresponding to the performance based on the acquired performance information, and causes the server 3 to store the second image and the performance information. Then, the control unit 11 acquires the URL information for accessing the stored second image and the performance information from the server 3, and instructs the label printer 5, the display device 4, or the display unit 14 to output the acquired URL information. Therefore, the URL information for accessing the second image and the performance information can be automatically provided to the performer without manual (user) intervention. Therefore, the second image and the performance information generated in accordance with the performance can be easily shared with others.

For example, the control unit 11 generates the two-dimensional code representing the URL information and instructs the output of the generated two-dimensional code to the label printer 5, the display device 4, or the display unit 14 to output the generated two-dimensional code.

Therefore, the performer can easily access the second image and the performance information by holding the user terminal 6 over the two-dimensional code. In addition, since the performer can bring back the two-dimensional code, it is also possible to access the second image and the performance information later.

For example, the control unit 11 generates the thumbnail of the second image and instructs the label printer 5 to output the two-dimensional code and the thumbnail. Therefore, the performer can identify his or her own two-dimensional code, and it is possible to prevent another performer from mistakenly bringing back the label on which the two-dimensional code of another performer is printed.

Further, for example, the control unit 11 acquires performance date and time information in which a performance corresponding to the performance information has been performed and instructs the label printer 5 to output the two-dimensional code and performance date and time information. Therefore, it is possible for the player to identify his or her own two-dimensional code, and it is possible to prevent another player from erroneously bringing back the two-dimensional code.

For example, the control unit 11 superimposes the two-dimensional code on the second image and instructs the display device 4 or the display unit 14 to output the second image superimposed with the two-dimensional code. Therefore, the performer can easily access the second image and the performance information by holding the user terminal 6 over the two-dimensional code.

For example, the control unit 11 generates the digital watermark image in which the URL information is embedded in the second image, and instructs the display device 4 or the display unit 14 to output the digital watermark image. Therefore, the second image and the performance information can be easily accessed only by photographing the digital watermark image with the user terminal 6 installed with an application for reading information embedded in the digital watermark image.

Further, for example, the server 3 generates the Web page for viewing the second image and listening the performance based on the performance information and generates the URL information of the Web page, and transmits the generated Web page and the URL information to the information processing apparatus 1. Therefore, the performer can easily view the second image and listening the performance based on the performance information.

For example, when the server 3 receives a request to download the second image from the user terminal 6 accessed based on the URL information, the server 3 acquires screen information of the display screen of the user terminal 6 from the user terminal 6, generates a reconstructed image corresponding to the display screen of the user terminal 6 based on the acquired screen information as the second image, and transmits the generated reconstructed image to the user terminal 6.

Therefore, the second image corresponding to the display screen of the user terminal 6 can be provided to the performer.

It should be noted that the description contents in the above-described embodiment and the variation embodiments are examples of the information processing method, information processing apparatus, program, and information processing system according to the present disclosure, and are not limited thereto.

For example, in the above-described embodiment, the information processing apparatus 1 and the electronic musical instrument 2 are described as being separate from each other. However, the information processing apparatus 1 and the electronic musical instrument 2 can be integrated. For example, the function of the information processing apparatus 1 can be provided in the electronic musical instrument 2.

In the above embodiment, the storage device is the server 3, the second image, the performance information and the image parameter are stored in the server 3, and the server 3 generates the URL information for accessing the second image and the performance information. However, the storage unit 12 of the information processing apparatus 1 can function as the storage device. That is, the control unit 11 of the information processing apparatus 1 can store the second image, the performance information, and the image parameter in the storage unit 12 of the information processing apparatus 1, and generate the URL information for accessing the second image and the performance information. For example, the control unit 11 can store the second image, the performance information, and the image parameter in the storage unit 12 of the information processing apparatus 1, generate the Web page for viewing the second image and listening the performance based on the performance information, and generate the URL information for accessing the Web page.

In the above-described embodiment, in order to provide both the second image and the performance information to the performer, the second image and the performance information are stored, and address information (the URL information) for accessing both is generated and output. However, only one of them can be stored, and the URL information for accessing the only one of them can be generated and output. The Web page described above can also be the Web page for viewing or for listening either the second image or the performance information.

In the above embodiment, the Web page for viewing the second image and listening the performance based on the performance information is generated, and the URL information for accessing the Web page is generated and output. However, it is also possible to generate and output the URL information for accessing the storage location of the second image and the performance information. Further, the address information is not limited to the URL information.

Further, in the above-described embodiment and the modified example, the URL information is outputted as the two-dimensional code or the digital watermark image and is provided to the performer. However, characters representing the URL information can be output.

In the above-described embodiment, the electronic musical instrument 2 is a keyboard musical instrument. However, other electronic musical instruments such as electric guitars and MIDI violins can be used.

In the above-described embodiments, an example in which a ROM is used as a computer-readable medium for a program according to the present disclosure has been disclosed. However, the present invention is not limited to this example. As another computer-readable medium, a portable recording medium such as a hard disk, an SSD, or a CD-ROM can be applied. As a medium for providing data of a program according to the present disclosure through a communication line, a carrier wave is also applied.

In addition, the detailed configuration and detailed operation of each device constituting the information processing system can be appropriately changed without departing from the spirit of the invention. These processes can be executed by a plurality of computers.

Although embodiments and modifications of the present disclosure have been described above, the technical scope of the present disclosure is not limited to the embodiments described above, but is determined based on the claims. In addition, the technical scope of the present disclosure includes equivalent ranges in which changes unrelated to the essence of the present disclosure are made from the claims.

What is claimed is:

1. An information processing method performed by at least one processor, the method comprising:
acquiring performance information corresponding to performance operation;
generating an image based on the performance information;
storing at least one of the image and the performance information in a storage device;
acquiring address information for accessing the at least one of the image and the performance information stored in the storage device; and
controlling an output device to output the address information.

2. The information processing method according to claim 1,
generating a two-dimensional code representing the address information; and
controlling the output device to output the two-dimensional code representing the address information.

3. The information processing method according to claim 2,
generating a thumbnail of the image; and
controlling the output device to output the two-dimensional code and the thumbnail.

4. The information processing method according to claim 2,
acquiring performance date and time information corresponding to the performance operation; and
instructing the output device to output the two-dimensional code and the performance date and time information.

5. The information processing method according to claim 2, wherein the output device is a label printer.

6. The information processing method according to claim 2,
generating a second image by superimposing the two-dimensional code onto the image; and
controlling the output device to output the superimposed image on which the two-dimensional code is superimposed.

7. The information processing method according to claim 1,
generating a digital watermark image in which the address information is embedded in the image; and
controlling the output device to output the digital watermark image.

8. The information processing method according to claim 6, wherein the output device is a display device.

9. The information processing method according to claim 1, wherein the address information is address information of a Web page for viewing the image or for listing to the performance based on the performance information.

10. An information processing apparatus comprising:
at least one processor, wherein the at least one processor is configured to perform the following:
acquiring performance information corresponding to performance operation;
generating an image based on the performance information;
storing at least one of the image and the performance information in a storage device;
acquiring address information for accessing at least the one of the image and the performance information stored in the storage device; and
controlling an output device to output the address information.

11. A non-transitory computer-readable storage medium storing a program that causes at least one computer to execute a process comprising:
acquiring performance information corresponding to performance operation;
generating an image based on the acquired performance information;
storing at least one of the image and the performance information in a storage device;
acquiring address information for accessing at least one of the image and the performance information stored in the storage device; and
controlling an output device to output the acquired address information.

12. An information processing system comprising:
an information processing apparatus;
a server; and
an output apparatus,
wherein the information processing apparatus comprising at least one processor that perform the following:
acquiring performance information corresponding to performance operation;
generating an image based on the performance information; and
transmitting at least one of the image and the performance information to the server,
wherein the server comprising at least one processor that perform the following:
storing the at least one of the image and the performance information;
generating address information for accessing at least one of the stored image and performance information; and
transmitting the address information to the information processing apparatus,
wherein the information processing apparatus comprising the at least one processor that perform the following:
acquiring the address information transmitted from the server; and
controlling the output apparatus to output the acquired address information,
wherein the output apparatus comprising at least one processor that perform the following:
outputting the address information.

13. The information processing system according to claim 12, wherein the server performs the following:
generating a Web page for viewing the image and for listening a performance based on the performance information;
generating address information of the Web page; and
transmitting the Web page and the address information to the information processing apparatus.

14. The information processing system according to claim 12, wherein the server performs the following:
acquiring screen information of a display screen of a terminal device from the terminal device in case which the server receives a download request of the image from the terminal device that accessed based on the address information;
generating a reconstructed image by reconstructing the image according to the display screen of the terminal device based on the acquired screen information; and
transmitting the generated reconstructed image to the terminal device.
